(19) United States
(12) Patent Application Publication
(10) Pub. No.: US 2011/0008235 A1
(43) Pub. Date: Jan. 13, 2011

(54) METHOD FOR MODERATE TEMPERATURE REUTILIZATION OF IONIC HALIDES

(76) Inventors: Angel Sanjurjo, San Jose, CA (US); Lorenza Moro, San Carlos, CA (US); Jordi Perez Mariano, Menlo Park, CA (US); Kai-Hung Lau, Cupertino, CA (US); Xiaobing Xie, Foster City, CA (US); Anoop Nagar, Palo Alto, CA (US); Marc Hornbostel, Palo Alto, CA (US); Gopala N. Krishnan, Sunnyvale, CA (US)

Correspondence Address: Wall & Tong, LLP;SRI INTERNATIONAL, 25 James Way, Eatontown, NJ, 07724, US

(21) Appl. No.: 12/499,513

(22) Filed: Jul. 8, 2009

(51) Int. Cl. C01B 33/107; C01B 33/10; C22B 5/00

(52) U.S. Cl. 423/342; 423/341; 75/711

(57) ABSTRACT

In one embodiment, the present invention relates generally to a method for reutilizing ionic halides in a production of an elemental material. In one embodiment, the method includes reacting a mixture of an ionic halide, at least one of: an oxide, suboxide or an oxyhalide of an element to be produced and an aqueous acid solution at moderate temperature to form a complex precursor salt and a salt, forming a precursor halide from the complex precursor salt, reducing the precursor halide into the element to be produced and the ionic halide and returning the ionic halide into the mixture of the reacting step.

### FIELD OF THE INVENTION

The present invention relates generally to reutilization of ionic halides during production of elemental materials and more specifically, a method for moderate temperature reutilization of ionic halides.

### BACKGROUND OF THE INVENTION

Current processes for producing elements such as semiconductors, metals and metalloids create various by-products. Some of these by-products may be recycled within the process or may be purified and sold to other industries. However, some of the by-products may not have a large demand in other industries.

Industrial plant sizes for the production of elements, for example solar grade silicon (Si) or titanium (Ti) are expected to increase drastically over the next several years. One by-product in the production of elements by reduction of their halides, such as silicon tetrafluoride (SiF₄), by reactive metals, such as sodium (Na), is ionic halides, such as for example, sodium fluoride (NaF). It is predicted that traditional markets for ionic halides such as the metallurgical industry, pharmaceutical industry, etc., may not be able to absorb such large production of ionic halides such as NaF. Furthermore, NaF is an alternative to hydrofluoric acid (HF), which is used to attack silicon dioxide (SiO₂) and generate SiF₄.

### SUMMARY OF THE INVENTION

In one embodiment, the present invention relates generally to a method for reutilizing ionic halides in a production of elemental materials. The method includes reacting a mixture of an ionic halide, at least one of: an oxide, suboxide or an oxyhalide of an element to be produced and an aqueous acid solution at moderate temperature to form a complex precursor salt and a salt, forming a precursor halide from said complex precursor salt, reducing said precursor halide into said element to be produced and said ionic halide and returning said ionic halide into said mixture of said reacting step.

In one embodiment, the present invention is directed towards a method for reutilizing ionic halides in a production of a complex precursor salt. The method comprises forming an ionic halide during a reduction of a precursor halide to produce an element, recycling said ionic halide with a mixture of at least one of: an oxide, a suboxide or an oxyhalide of said element and an aqueous acid solution at moderate temperature and forming said complex precursor salt.

In one embodiment, the present invention is directed towards a method for reutilizing sodium fluoride (NaF) in a production of sodium fluorosilicate (NaSiF₆). The method comprises forming said NaF during a reduction of a silicon tetrafluoride (SiF₄) gas to produce pure silicon, recycling said NaF with a mixture of silicon dioxide (SiO₂) and hydrochloric acid (HCl) solution at a moderate temperature and forming said NaSiF₆.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a flow diagram of one example of a process for producing high purity silicon by a process that may utilize the present invention;

FIG. 2 depicts one embodiment of a process flow diagram for reutilizing ionic halides in production of elemental materials;

FIG. 3 depicts a flow diagram of one embodiment of a method of reutilizing ionic halides in production of elemental materials;

FIG. 4 depicts a flow diagram of a second embodiment of a method of reutilizing ionic halides in production of complex precursor salts, which can be used in the production of elemental materials;

FIG. 5 depicts a flow diagram of one embodiment of a method for reutilizing sodium fluoride (NaF) in production of sodium fluorosilicate (NaSiF₆), which can be used in the production of silicon;

FIG. 6 depicts an embodiment of a second process flow diagram for reutilizing ionic halides in production of elemental materials; and

FIG. 7 depicts a second embodiment of a third process flow diagram for reutilizing ionic halides in production of elemental materials.

To facilitate understanding, identical reference numerals have been used, where possible, to designate identical elements that are common to the figures.

### DETAILED DESCRIPTION

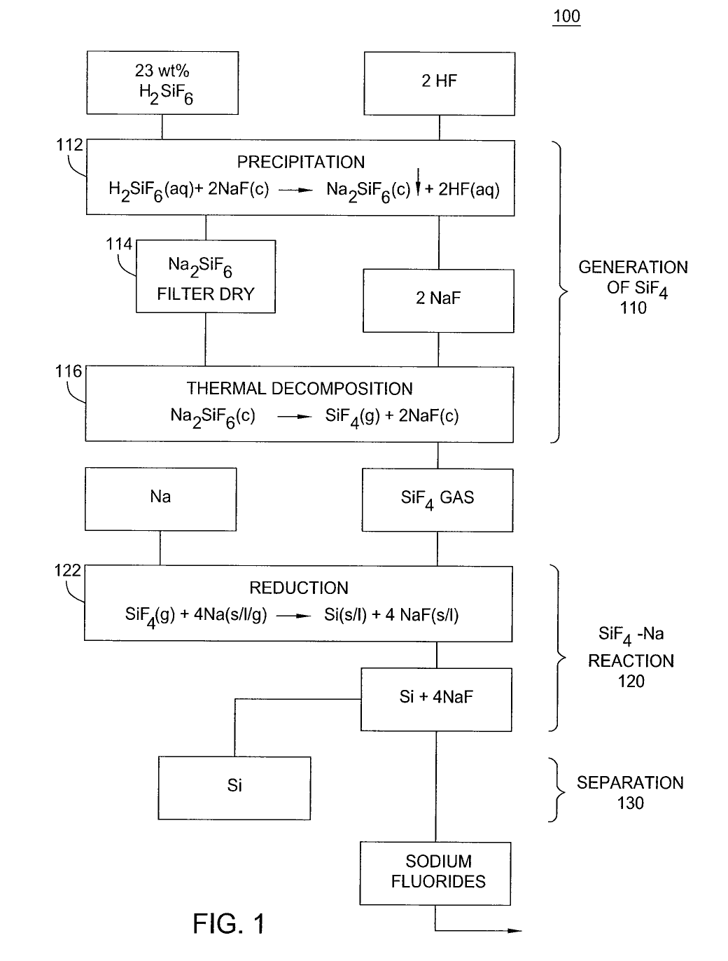

A brief discussion of a process of producing high purity silicon from fluorosilicic acid will aid the reader on understanding a useful application of one embodiment of the present invention. An overall process 100 illustrated in FIG. 1 consists of three major operations which encompass a series of steps. The first major operation includes the step of precipitation of a complex precursor salt, such as for example sodium fluorosilicate (Na₂SiF₆), from fluorosilicic acid (H₂SiF₆) and a salt, such as for example sodium fluoride (NaF) or sodium chloride (NaCl), followed by generation of a precursor halide, such as for example silicon tetrafluoride gas (SiF₄) by thermal decomposition or treatment with a strong acid, illustrated as a block of steps 110 in FIG. 1. The precipitation of sodium fluorosilicate from fluorosilicic acid comprises a reaction equation as shown below by Eq. (1) and in sub-step 112 of FIG. 1.

H₂SiF₆(aq)+2NaF(c)=Na₂SiF₆(c)+2HF(aq) Eq. (1)

The sodium fluorosilicate is filter dried in sub-step 114. Since the impurities with higher solubility than Na₂SiF₆ remain preferentially in the aqueous solution, the precipitation and filtration of Na₂SiF₆ results in a purification step beneficial towards the production of high purity silicon. Subsequently, the sodium fluorosilicate is thermally decomposed in step 116 with heat. In one embodiment, the sodium fluorosilicate may be heated up to temperatures in the range of 600 degrees Celsius (° C.) to 1000° C. The reaction equation for the thermal decomposition of sodium fluorosilicate is shown below by Eq. (2) and in sub-step 116 of FIG. 1.

Na₂SiF₆(c)+heat=SiF₄(g)+2NaF(c) Eq. (2)

The second major operation comprises the reduction of the precursor halide, such as for example silicon tetrafluoride (SiF₄) gas, to an elemental material, such as for example silicon (Si), and an ionic halide, such as for example sodium fluoride (NaF). In one embodiment, the SiF₄ is reduced by sodium metal (Na) as illustrated by a block of steps 120 in FIG. 1. The reduction of the silicon tetrafluoride gas to silicon is shown below by Eq. (3) and in sub-step 122 of FIG. 1.

SiF₄(g)+4Na(s/l/g)=Si(s/l)+4NaF(s/l) Eq. (3)

The third major operation involves the separation of the produced elemental material, such as silicon (Si), from the mixture of the elements and the ionic halide, such as sodium fluoride (NaF), as shown in a block of steps 130 in FIG. 1. Further details of each of the above identified operations are disclosed in U.S. Pat. Nos. 4,442,082, 4,584,181 and 4,590,043, which are hereby incorporated by reference. Moreover, the above steps are merely provided as an example and are not to be considered limiting. In addition, although the above process is illustrated for the production of pure silicon, the process may be applied to other elemental materials such as boron (B), aluminum (Al), titanium (Ti), vanadium (V), zirconium (Zr), niobium (Nb), molybdenum (Mo), tungsten (W), tantalum (Ta), uranium (U) or plutonium (Pu).

Previously, the ionic halide, for example sodium fluoride in the embodiment illustrated in FIG. 1, that was separated from the element, for example Si, was packaged and sold. In addition, if the ionic halide could not be sold, the ionic halide was disposed of creating higher raw material costs and lower revenue.

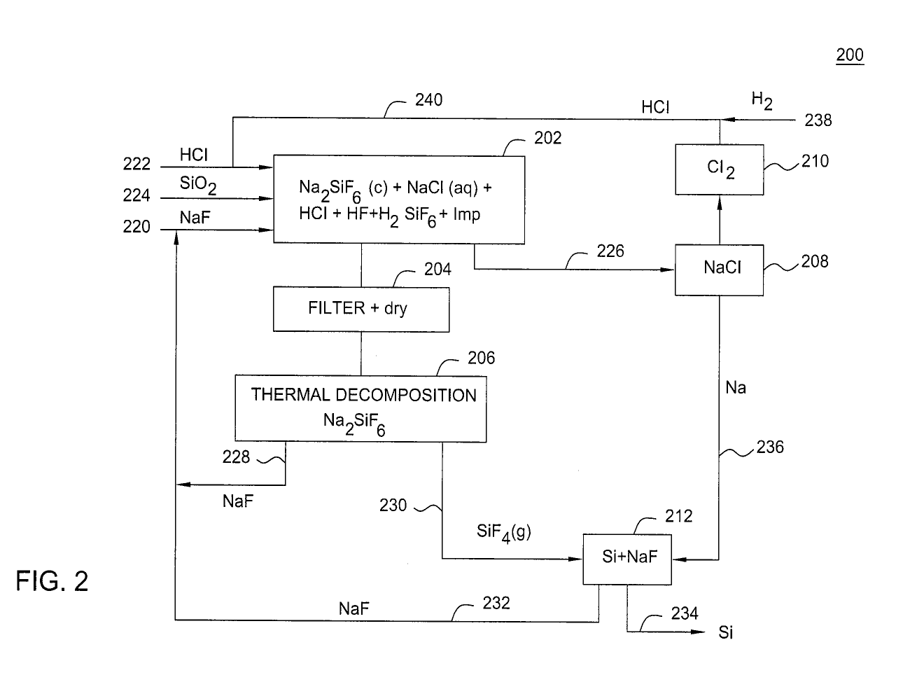

FIG. 2 illustrates one embodiment of the present invention of a process 200 for reutilizing ionic halides in production of an elemental material. For example, the process 200 may be used to reutilize NaF produced during the production of silicon from fluorosilicic acid received from the phosphate industry, as illustrated by example in FIG. 1, or from silicon dioxide (SiO₂) from any mineral or industrial sources.

In one embodiment, an ionic halide or its aqueous solution, for example NaF, may be reacted with an aqueous solution of an acid, for example an acid of a halide, such as for example, hydrochloric acid (HCl) or hydrobromic acid (HBr), sulfuric acid (H₂SO₄), nitric acid (HNO₃) or any organic acid such as acetic acid (CH₃COOH), which sodium salts have a high solubility in, and at least one of an oxide, a suboxide or an oxyhalide of the element to be produced, for example silicon dioxide (SiO₂) or an oxyhalide of Ti, V, Zr, Nb, Mo, Ta, W, U or Pu, in a vessel 202 via streams 220, 222 and 224, respectively. Hereinafter, oxide may be used to also refer to a suboxide or an oxyhalide where appropriate. The vessel 202 may be a reactor and may be heated. The materials of construction for the vessel 202 may be Teflon-lined steel, nickel or Inconel for temperatures of operation up to 150° C., and lead-lined steels for temperatures up to 250° C.

In one embodiment, the oxide of the element to be produced may be provided in small particles. For example, the particle size of the oxide may be from 100 nanometers (nm) to 1 centimeter (cm). In another embodiment, the particle size of the oxide may be from 1 micron (μm) to 1 millimeter (mm). In yet another embodiment, the particle size of the oxide may be from 1 μm to 50 μm.

The mixture of the ionic halide, the acid and the oxide react to form a complex precursor salt, for example sodium fluorosilicate (Na₂SiF₆) for Si production or sodium fluorotitanate (Na₂TiF₆) for Ti production, and a solution containing impurities. In addition, a salt or salt solution may be formed. The salt or salt solution may comprise at least one element from the ionic halide and at least one element from the acid. For example, in the example illustrated in FIG. 2, the salt or the salt solution may be of sodium chloride (NaCl) produced from an element from the NaF and a halide from the acid.

Referring back to the mixture, the reaction of the mixture may notably occur at a moderate temperature. In one embodiment, “moderate temperature” may be defined as being a temperature within a range of approximately 20° C. to 250° C. In another embodiment, “moderate temperature may be defined as being a temperature within a range of approximately 40° C. to 150° C. In yet another embodiment, “moderate temperature may be defined as being a temperature within a range of approximately 60° C. to 90° C.

In one embodiment, where the ionic halide is NaF, the acid is HCl and the oxide of the element to be produced is SiO₂, the reaction to produce the complex precursor salt, for example Na₂SiF₆, is illustrated below by equations (4)-(7). Equations (4)-(6) illustrate the intermediate reactions and equation (7) illustrates the overall reaction.

NaF(aq)+HCl(aq)→HF(aq)+NaCl(aq) Eq. (4)

6HF(aq)+SiO₂(s)→H₂SiF₆(aq)+2H₂O(aq) Eq. (5)

2NaCl(aq)+H₂SiF₆(aq)→Na₂SiF₆(s)+2HCl(aq) Eq. (6)

4HCl(aq)+6NaF(aq)+SiO₂(s)→Na₂SiF₆(s)+4NaCl(aq)+2H₂O(aq) Eq. (7)

As illustrated by vessel 202 in FIG. 2, at any given time vessel 202 may contain other intermediate compounds such as Na₂SiF₆, NaCl, HCl, HF, H₂SiF₆ and impurities. In one embodiment, the Na₂SiF₆ may be filtered and dried at 204, similar to step 114 in FIG. 1 and thermally decomposed at 206, similar to step 116 in FIG. 1. During thermal decomposition at 206, an ionic halide, for example NaF, may be produced and removed via stream 228 and fed back into stream 220 for reutilization to re-generate the complex precursor salt, for example Na₂SiF₆.

Referring back to the thermal decomposition at 206, the thermal decomposition may also produce a precursor halide, such as for example, silicon tetrafluoride (SiF₄) via stream 230.

The SiF₄ may be reduced at 212 to produce pure silicon out of stream 234 and NaF out of stream 232 similar to step 122 in FIG. 1. In one embodiment, sodium (Na) may be used to reduce the SiF₄. The Na used for reducing the SiF₄ may be Na fed via stream 236 and produced via electrolysis of NaCl leaving vessel 202 via stream 226, as noted above. At 208, the NaCl may be separated via electrolysis to produce Na in stream 236 and chlorine gas (Cl₂) at 210. The Cl₂ may be reacted with a stream of hydrogen 238, for example in water, to produce HCl in stream 240 that may be recycled back into stream 222.

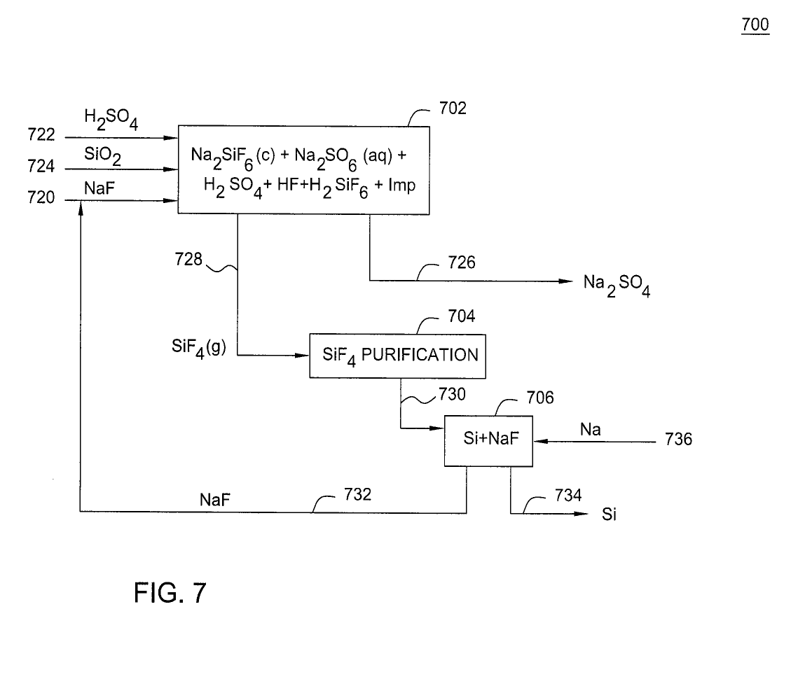

Alternatively, the solution containing SiF₆²⁻ anions or the Na₂SiF₆ can be reacted with a strong acid, such as sulfuric acid (H₂SO₄), to generate SiF₄ gas directly. This embodiment is illustrated below with reference to FIG. 7.

Referring back to stream 232, the NaF produced from the reduction of SiF₄ with Na may be recycled back into stream 220 to be reacted with a mixture of the SiO₂ and HCl to produce more Na₂SiF₆. In one embodiment, the NaF provides a double source of fluorine ions to generate HF, which is used to attack the SiO₂ and form SiF₆²⁻ and sodium ions to obtain Na₂SiF₆ through precipitation of this solid with low solubility.

As noted above, the reaction between NaF, HCl and SiO₂ may occur at a moderate temperature and may include some agitation or stirring. In one embodiment, moderate temperature may be defined, as noted above, as being a temperature within a range of approximately 20° C. to 250° C. Also, process 200 requires minimal raw materials to be introduced into the system, for example low cost SiO₂ or sand that is readily available at minimal cost and some make-up NaF and HCl.

Although the FIG. 2 illustrates by example the recycling of NaF during the production of Na₂SiF₆, the present invention may be applied to recycling various ionic halides during production of various elements. For example, the ionic halide may be any alkali metal halide, an alkali earth metal halide, a halide of zinc or a halide of aluminum.

Similarly, the oxide of the element to be produced may be any oxide and not limited to silicon dioxide. For example, the oxide may include boron (B), aluminum (Al), silicon (Si), titanium (Ti), vanadium (V), zirconium (Zr), niobium (Nb), molybdenum (Mo), tantalum (Ta), tungsten (W), uranium (U), plutonium (Pu), or any Ti suboxide such as Ti₃O₅, Ti₂O₃ or TiO₂₋ₓ, where x can be any real number between 0 and 1. For example, the oxide may be silicon dioxide (SiO₂), titanium dioxide (TiO₂) or a titanate such as calcium titanate (CaTiO₃) or ilmenite (FeTiO₃). Also included by example is an oxyhalide of Ti, V, Zr, Nb, Mo, Ta, W, U and Pu. The type of oxide may be determined by the desired type of elemental material that is to be produced. For example, if the process 200 is to be used to produce pure silicon, then SiO₂ may be used. Alternatively, if the process 200 is to be used to produce pure titanium metal, then TiO₂, Ti₃O₅, Ti₂O₃, TiO₂₋ₓ, CaTiO₃ or FeTiO₃ may be used. Alternatively, if the process 200 is to be used to produce pure boron, then Na₃BO₃ may be used.

The precursor halide may also be any precursor halide and not limited to SiF₄. For example, the precursor halide may include boron (B), aluminum (Al), silicon (Si), titanium (Ti), vanadium (V), zirconium (Zr), niobium (Nb), molybdenum (Mo), tantalum (Ta), tungsten (W), uranium (U) or plutonium (Pu). The type of precursor halide may be determined by the desired type of elemental material that is to be produced. For example, if the process 200 is to be used to produce pure silicon, then SiF₄ gas or Na₂SiF₆ solid may be produced. Alternatively, if the process 200 is to be used to produce pure titanium metal, then TiF₄ solid or Na₂TiF₆ solid, may be produced. Similarly, for the production of uranium, uranium tetrafluoride UF₄ may be used. Similarly, the halide in the precursor halide may be any type of halide and is not limited to only fluorine (F). Other halides such as, for example, chlorides, bromides and iodides may be used.

The salt produced from the reaction in vessel 202 may be any salt depending on the ionic halide and the acid used and is not limited to NaCl. For example, when sulfuric acid (H₂SO₄) is used as illustrated in FIG. 7, the salt may comprise sodium sulphate (Na₂SO₄). Thus, the salt may be any salt including at least one element from the ionic halide and at least one element from the acid. The acid may be any acid of a halide and not limited to only HCl. Other acids may also be used such as, for example, H₂SO₄, nitric acid (HNO₃) or acetic acid (CH₃COOH).

The complex precursor salt may also be any type of halide complex salt and not limited to only Na₂SiF₆. For example, the precursor salt will also depend on the desired type of elemental material that is to be produced. For example, if the process 200 is to be used to produce pure silicon, then a fluorometallic compound such as Na₂SiF₆ may be used. Alternatively, if the process 200 is to be used to produce pure titanium metal, then a fluorotitanate such as, Na₂TiF₆, K₂TiF₆, CaTiF₆ and the like, may be used.

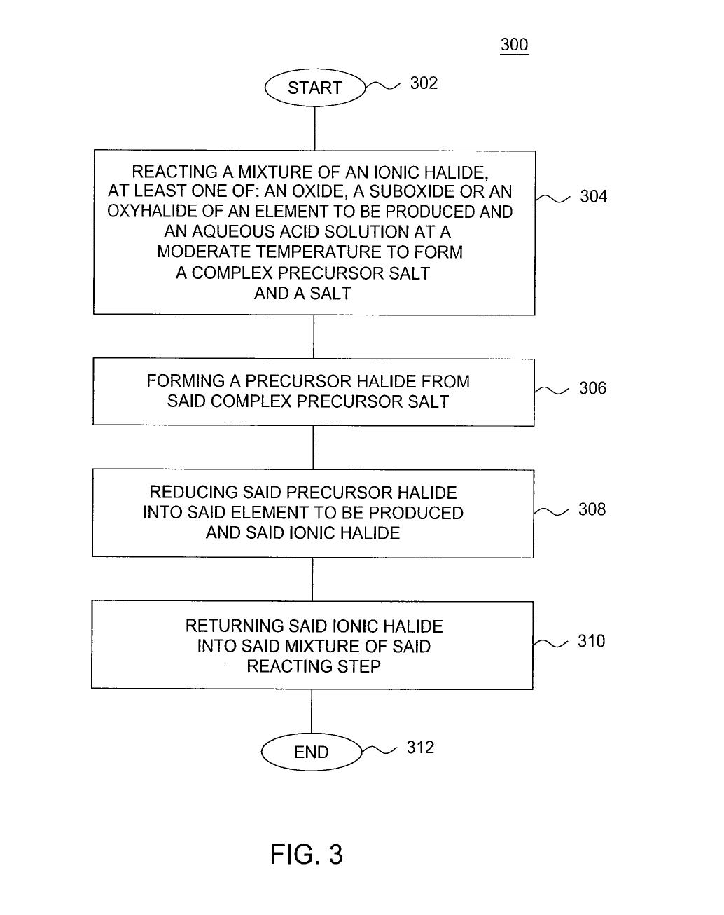

FIG. 3 illustrates a flow diagram of one embodiment of a method 300 for reutilizing ionic halides in production of elemental materials. In one embodiment, the method 300 may be carried out in the process 200 illustrated in FIG. 2.

The method 300 begins at step 302. At step 304, the method 300 reacts a mixture of an ionic halide, at least one of an oxide, a suboxide or an oxyhalide of an element to be produced and an aqueous acid solution at a moderate temperature to form a complex precursor salt and a salt. As defined above, moderate temperature may be a temperature within a range of approximately 20° C. to 250° C. The ionic halide, the oxide and the aqueous acid solution may be any one of the ionic halides, oxides and acids described above. The complex precursor salt and the salt may be any one of the complex precursor salts and salts described above.

The method 300 at step 306 forms a precursor halide from the complex precursor salt. For example, as described above, when the complex precursor salt is thermally decomposed, a precursor halide may be formed. The halide may be any one of the halides as described above.

The method 300 at step 308 reduces the precursor halide into the element to be produced and the ionic halide. As described above, the precursor halide may be reduced to form a desired element and the ionic halide. The element may be any one of the desired elements as described above.

The method 300 at step 310 returns the ionic halide into the mixture of the reacting step 304. Thus, the generated ionic halide formed from reduction of the precursor halide to produce a desired element may be reutilized or recycled within the process. The method 300 concludes at step 312.

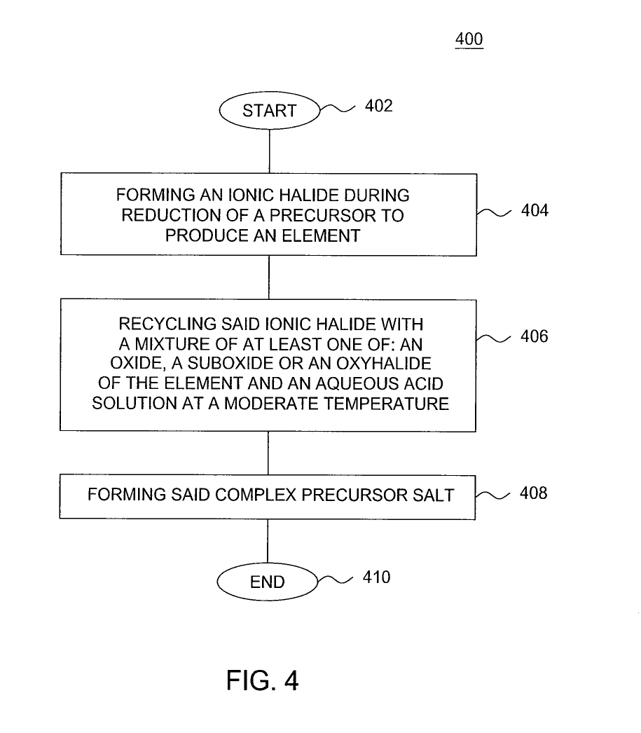

FIG. 4 illustrates a flow diagram of another embodiment of a method 400 for reutilizing ionic halides in production of a complex precursor salt. In one embodiment, the method 400 may be carried out in the process 200 illustrated in FIG. 2.

The method 400 begins at step 402. At step 404, the method 400 forms an ionic halide during reduction of a precursor halide to produce an element. The ionic halide, the precursor halide and the element may be any one of the ionic halides, precursor halides or elements as described above.

At step 406, the method 400 recycles the ionic halide with a mixture of at least one of an oxide, a suboxide and an an oxyhalide of the element and an aqueous acid solution at a moderate temperature. The oxide and the aqueous acid solution may be any one of the oxides or acids discussed above. As defined above, moderate temperature may be a temperature within a range of approximately 20° C. to 250° C.

At step 408, the method 400 forms the complex precursor salt. As described above, the complex precursor salt may be produced from the reaction of the mixture of the ionic halide, the oxide and the aqueous acid solution at a moderate temperature. The method 400 concludes at step 410.

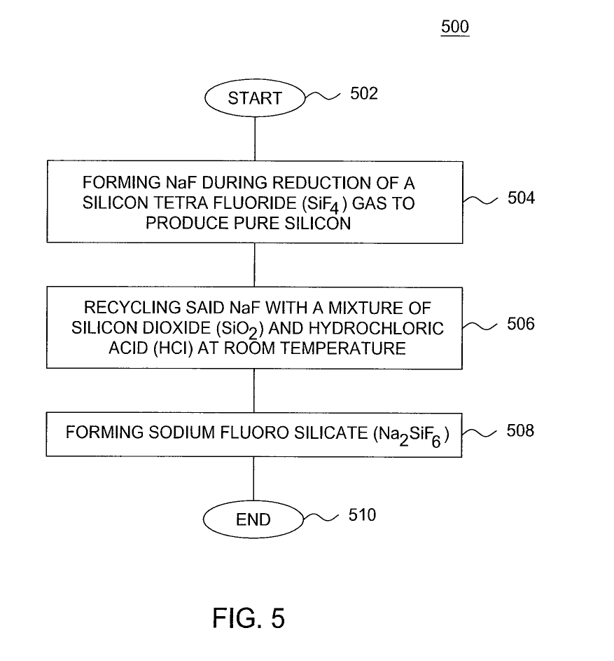

FIG. 5 illustrates a flow diagram of one embodiment of a method 500 for reutilizing NaF in production of sodium fluorosilicate (NaSiF₆). In one embodiment, the method 500 may be carried out in the process 200 illustrated in FIG. 2.

The method 500 begins at step 502. At step 504, the method 500 forms NaF during reduction of a silicon tetra fluoride (SiF₄) gas to produce pure silicon.

At step 506, the method 500 recycles the NaF with a mixture of silicon dioxide (SiO₂) and an aqueous hydrochloric acid (HCl) solution at a moderate temperature.

At step 508, the method 500 forms the Na₂SiF₆. The method 500 concludes at step 510.

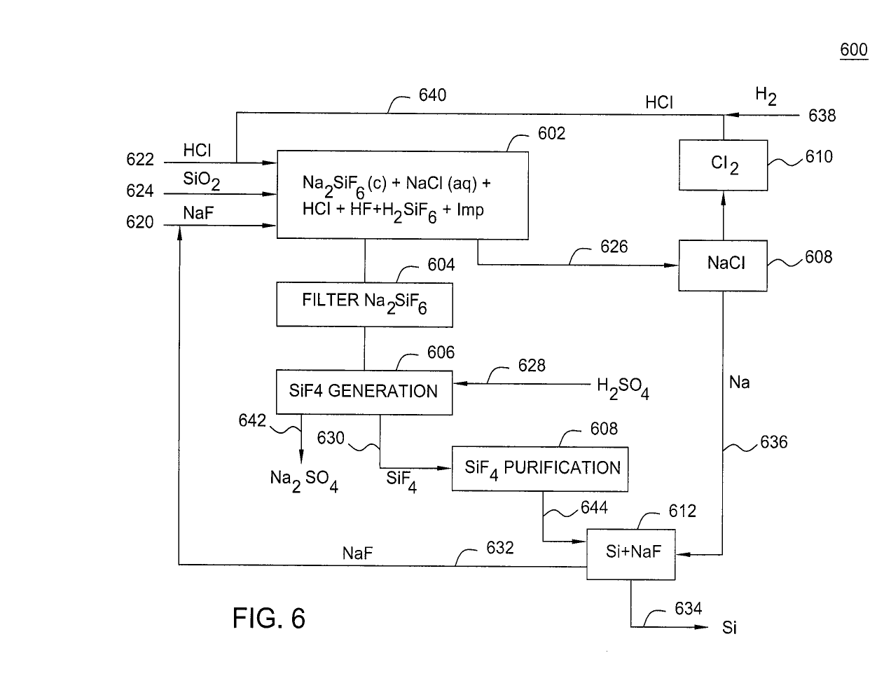

FIG. 6 illustrates one embodiment of the present invention of a process 600 for reutilizing ionic halides in production of an elemental material. For example, the process 600 may be used to reutilize NaF produced during the production of silicon from fluorosilicic acid received from the phosphate industry, or from silicon dioxide (SiO₂) from any mineral or industrial sources.

The process 600 differs from the process 200 only in the step in which the precursor halide is generated from the complex precursor salt. The rest of the steps are as discussed above for the process 200.

In one embodiment, the complex precursor salt, for example Na₂SiF₆, may be filtered at 604, similar to 204 in FIG. 2, but not necessarily dried. The complex precursor salt may be mixed with a solution of a strong acid via stream 628, such as for example sulfuric acid (H₂SO₄) in a vessel 606. The vessel 606 may be a reactor and may be heated. The materials of construction for the vessel 606 may be any of the mentioned above for vessel 202. The mixture in the vessel 606 may produce a precursor halide, such as for example, silicon tetrafluoride (SiF₄) via stream 630 and a salt or a solution, such as for example, that of Na₂SO₄ via stream 642. Notably, the reaction in the vessel 606 may occur at a moderate temperature. In one embodiment, “moderate temperature” may be defined as being a temperature within a range of approximately 20° C. to 250° C. In another embodiment, “moderate temperature may be defined as being a temperature within a range of approximately 40° C. to 150° C. In yet another embodiment, “moderate temperature may be defined as being a temperature within a range of approximately 60° C. to 90° C. The precursor halide may be cleaned at 608 from other components, such as water, HF or Si₂OF₆ and reduced at 612 to produce the element, such as Si, out of stream 634 and an ionic halide, such as NaF, out of stream 632, which can be recycled back into stream 620.

The ionic halide, the precursor halide, the oxide of the element to be produced and the element may be any one of the ionic halides, precursor halides, oxides or elements as described above.

FIG. 7 illustrates one embodiment of the present invention of a process 700 for reutilizing ionic halides in production of an elemental material. For example, the process 700 may be used to reutilize NaF produced during the production of silicon from fluorosilicic acid received from the phosphate industry, or from silicon dioxide (SiO₂) from any mineral or industrial sources.

In one embodiment, an ionic halide, for example NaF, may be reacted with an aqueous solution of a strong acid, for example sulfuric acid (H₂SO₄), and an oxide of the element to be produced, for example silicon dioxide (SiO₂), in a vessel 702 via streams 720, 722 and 724, respectively. The vessel 702 may be a reactor and may be heated. The materials of construction for vessel 702 may be any of the mentioned above for vessel 202.

The mixture in 702 may produce a precursor halide, such as for example, silicon tetrafluoride (SiF₄) via stream 728 and a salt, such as for example Na₂SO₄ via stream 726. Notably, in FIG. 7, the precursor salt may be formed in-situ. That is, the complex precursor salt and the precursor halide are not formed in separate steps as illustrated in FIG. 2.

In addition, the reaction may occur at a moderate temperature. In one embodiment, “moderate temperature” may be defined as being a temperature within a range of approximately 20° C. to 250° C. In another embodiment, “moderate temperature may be defined as being a temperature within a range of approximately 40° C. to 150° C. In yet another embodiment, “moderate temperature may be defined as being a temperature within a range of approximately 60° C. to 90° C. The precursor halide may be cleaned at 704 from other components, such as water, HF, SOF₂ or Si₂OF₆, and reduced at 706 by a metal, such as Na, from stream 736 to produce the element, such as Si, out of stream 734 and an ionic halide, such as NaF, out of stream 732, which can be recycled back into stream 720.

The ionic halide, the precursor halide, the oxide of the element to be produced and the element may be any one of the ionic halides, precursor halides, oxides or elements as described above.

### EXAMPLE 1

The synthesis of Na₂SiF₆ by reaction of NaF, HCl solution and SiO₂ was performed. Stoichiometric amounts of the reactants (6:4:1 molar ratios of NaF, HCl and SiO₂) were used. 7.0 g of SiO₂ were added to a 200 mL aqueous solution of NaF and HCl that was previously heated at 80° C. Silica was used in the form of fine particles (crystalline quartz, Alfa Aesar, nominal surface area of 2 m²/g and average particle size of 2 microns). Right after adding silica to the solution, the temperature in the suspension increased by 7-10° C., due to the exothermic nature of the reaction, and the temperature dropped back to 80° C. in few minutes. The mixture was stirred at 80° C. for different amounts of time (0.25, 1, 2, 4 and 7 hours). After this time, the solids were recovered by filtration, washed with a limited amount of water and finally washed with methyl alcohol to expedite the drying process. Afterwards, they were dried in a convection oven, weighted and analyzed by means of X-ray diffraction (XRD) and thermogravimetric analysis (TGA). XRD did not detect any residual SiO₂ in any of the recovered solids. We estimate that the yield was over 90%.

### EXAMPLE 2

The synthesis of Na₂SiF₆ by reaction of NaF, HCl solution and SiO₂ was performed. Stoichiometric amounts of the reactants (6:4:1 molar ratios of NaF, HCl and SiO₂) were used. 7.0 g of SiO₂ were added to a 200 mL aqueous solution of NaF and HCl that was previously heated at 80° C. Silica was used in the form of fine particles (crystalline quartz, 60 wt % of it over 100 microns and 40 wt % in the range 20-100 microns). In these embodiments, there was no measurable temperature increase. Since the silica surface available for reaction is much smaller, the reaction rate is also slower. The mixture was stirred at 80° C. for different amounts of time (0.25, 2 and 4 hours). After this time, the solids were recovered by filtration, washed with a limited amount of water and finally washed with methyl alcohol to expedite the drying process. Afterwards, they were dried in a convection oven, weighted and analyzed by means of XRD and TGA. The results showed that Na₂SiF₆ was formed with a yield, in the 4 hour experiment, of 54.3%.

### EXAMPLE 3

The synthesis of Na₂SiF₆ by reaction of NaF, HCl solution and SiO₂ was performed. Stoichiometric amounts of the reactants (6:4:1 molar ratios of NaF, HCl and SiO₂) were mixed in 100 mL of aqueous solution. 3.6 g of SiO₂ in the form of fine amorphous SiO₂ particles were used (silica fumes, formed by agglomerates of particles with sizes below 400 nm). The mixture was stirred for 16 hours at approximately 24° C. After this time, the solids were recovered by filtration, washed with a limited amount of water and finally washed with methyl alcohol to expedite the drying process. Afterwards, they were dried in a convection oven, weighted and analyzed by means of XRD and TGA. The results showed that Na₂SiF₆ was formed with a yield of 85.4%

### EXAMPLE 4

The synthesis of Na₂SiF₆ by reaction of NaF, HCl solution and SiO2 was performed. Stoichiometric amounts of the reactants (6:4:1 molar ratios of NaF, HCl and SiO₂) were mixed in 100 mL of aqueous solution. 3.6 g of SiO₂ in the form of coarse sand were used (typical particle sizes in the range 250-450 microns). The mixture was stirred for 8 hours at approximately 60° C. After this time, the solids were recovered by filtration, washed with a limited amount of water and finally washed with methyl alcohol to expedite the drying process. Afterwards, they were dried in a convection oven, weighted and analyzed by means of XRD and TGA. The results showed that Na₂SiF₆ was formed with a yield of 47.0%.

### EXAMPLE 5

The synthesis of Na₂SiF₆ by reaction of NaF, HCl solution and SiO₂ was performed. Stoichiometric amounts of the reactants (6:4:1 molar ratios of NaF, HCl and SiO₂) were mixed in 100 mL of aqueous solution. 3.6 g of SiO₂ in the form of coarse sand were used (typical particle sizes in the range 250-450 microns). The mixture was stirred for 16 hours at approximately 24° C. After this time, the solids were recovered by filtration, washed with a limited amount of water and finally washed with methyl alcohol to expedite the drying process. Afterwards, they were dried in a convection oven, weighted and analyzed by means of XRD and TGA. The results showed that Na₂SiF₆ was formed with a yield of 34.5%.

### EXAMPLE 6

The synthesis of SiF₄ was done by reaction of Na₂SiF₆ with H₂SO₄. 50 mL of concentrated H₂SO₄ (17.8 M) were loaded into a PFA flask. The flask was purged with He and then heated using a water bath to 80° C. under He flow. After this, 18.8 g of Na₂SiF₆ were quickly added to the flask maintaining the flow of He through the system. The exhaust gas mixture was passed through an ice-cooled trap to condensate moisture and afterwards was passed through a cold trap, which was cooled by means of liquid nitrogen in order to condensate SiF₄. The evolution of SiF₄ was monitored by controlling the weight gain of the trap at several times. The weight of collected product reached 80% of the theoretical weight in 10 minutes, 97% in 30 minutes and 100% in 45 minutes.

### EXAMPLE 7

The synthesis of SiF₄ was done by reaction of H₂SiF₆ with H2SO4. 50 mL of concentrated H₂SO₄ (17.8 M) were loaded into a PFA flask. The flask was purged with He and then heated using a water bath to 80° C. under He flow. After this, 50 mL of H₂SiF₆ (20-25 wt %) were quickly added to the flask maintaining the flow of He through the system. The exhaust gas mixture was passed through an ice-cooled trap to condensate moisture and afterwards was passed through a cold trap, which was cooled by means of liquid nitrogen in order to condensate SiF₄. The evolution of SiF₄ was monitored by controlling the weight gain of the trap at several times. The weight of collected product reached 92% of the theoretical weight in 10 minutes, 95% in 35 minutes and 96% in 50 minutes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for reutilizing ionic halides in a production of elemental materials, the method comprising:
reacting a mixture of an ionic halide, at least one of: an oxide, a suboxide or an oxyhalide of an element to be produced and an aqueous acid solution at a moderate temperature to form a complex precursor salt and a salt;
forming a precursor halide from said complex precursor salt;
reducing said precursor halide into said element to be produced and said ionic halide; and
returning said ionic halide into said mixture of said reacting step.

2. The method of claim 1, wherein said ionic halide comprises at least one of: an alkali metal halide, an alkali earth metal halide, a halide of aluminum (Al) or a halide of zinc (Zn).

3. The method of claim 2, wherein said ionic halide comprises sodium fluoride (NaF).

4. The method of claim 1, wherein said oxide includes at least one of: boron (B), aluminum (Al), silicon (Si), titanium (Ti), vanadium (V), zirconium (Zr), niobium (Nb), molybdenum (Mo), tantalum (Ta), tungsten (W), uranium (U) or plutonium (Pu).

5. The method of claim 4, wherein said oxyhalide of said element to be produced comprises an oxyhalide of Ti, V, Zr, Nb, Mo, Ta, W, U or Pu.

6. The method of claim 1, wherein said aqueous acid solution comprises at least one of: an acid of a halide, sulfuric acid (H₂SO₄), nitric acid (HNO₃) or an organic acid.

7. The method of claim 6, wherein said aqueous acid solution comprises hydrochloric acid (HCl).

8. The method of claim 1, wherein said complex precursor salt comprises a fluorometallic compound.

9. The method of claim 1, wherein said precursor halide includes at least one of: boron (B), aluminum (Al), silicon (Si), titanium (Ti), vanadium (V), zirconium (Zr), niobium (Nb), molybdenum (Mo), tantalum (Ta) tungsten (W), uranium (U) or plutonium (Pu).

10. The method of claim 9, wherein said precursor halide comprises at least one of: silicon tetrafluoride (SiF₄), titanium tetrafluoride (TiF₄) or uranium tetrafluoride (UF₄).

11. The method of claim 1, wherein said salt comprises at least one element from said ionic halide and at least one element from said acid.

12. The method of claim 1, wherein said moderate temperature comprises a temperature between 20 degrees Celsius (° C.) to 250° C.

13. The method of claim 1, wherein said forming said precursor halide from said complex precursor salt comprises:
mixing said complex precursor salt with a strong acid at a moderate temperature.

14. The method of claim 13, wherein said strong acid comprises sulfuric acid (H₂SO₄).

15. The method of claim 13, wherein said moderate temperature comprises a temperature between 20 degrees Celsius (° C.) to 250° C.

16. The method of claim 1, wherein said complex precursor salt is formed in situ and said precursor halide is formed from said complex precursor salt in situ.

17. A method for reutilizing ionic halides in a production of a complex precursor salt, the method comprising:
forming an ionic halide during a reduction of a precursor halide to produce an element;
recycling said ionic halide with a mixture of at least one of: an oxide, a suboxide or an oxyhalide of the element and an aqueous acid solution at a moderate temperature; and
forming said complex precursor salt.

18. The method of claim 17, wherein said ionic halide comprises at least one of: an alkali metal halide, an alkali earth metal halide, a halide of aluminum (Al) or a halide of zinc (Zn).

19. The method of claim 18, wherein said metallic halide comprises sodium fluoride (NaF).

20. The method of claim 17, wherein said precursor halide includes at least one of: boron (B), aluminum (Al), silicon (Si), titanium (Ti), vanadium (V), zirconium (Zr), niobium (Nb), molybdenum (Mo), tantalum (Ta) tungsten (W), uranium (U) or plutonium (Pu).

21. The method of claim 20, wherein said oxide comprises at least one of: silicon dioxide (SiO₂) or titanium dioxide (TiO₂).

22. The method of claim 17, wherein said aqueous acid solution comprises at least one of: an acid of a halide, sulfuric acid (H₂SO₄), nitric acid (HNO₃) or an organic acid.

23. The method of claim 22, wherein said aqueous acid solution comprises hydrochloric acid (HCl).

24. The method of claim 17, wherein said complex precursor salt comprises a fluorometallic compound.

25. The method of claim 17, wherein said precursor halide includes at least one of: boron (B), aluminum (Al), silicon (Si), titanium (Ti), vanadium (V), zirconium (Zr), niobium (Nb), molybdenum (Mo), tantalum (Ta), tungsten (W) uranium (U) or plutonium (Pu).

26. The method of claim 25, wherein said precursor halide comprises at least one of: silicon tetrafluoride (SiF₄) or titanium tetrafluoride (TiF₄).

27. The method of claim 17, wherein said salt comprises at least one element from said ionic halide and at least one element from said acid.

28. The method of claim 17, wherein said moderate temperature comprises a temperature between 20 degrees Celsius (° C.) to 250° C.

29. A method for reutilizing sodium fluoride (NaF) in a production of sodium fluorosilicate (NaSiF₆), the method comprising:
forming said NaF during a reduction of silicon tetrafluoride (SiF₄) gas to produce pure silicon;
recycling said NaF with a mixture of silicon dioxide (SiO₂) and aqueous hydrochloric acid (HCl) solution at a moderate temperature; and
forming said NaSiF₆.

30. The method of claim 29, wherein said moderate temperature comprises a temperature between 20 degrees Celsius (° C.) to 250° C.
